(19) United States
(12) Patent Application Publication
(10) Pub. No.: US 2005/0069122 A1
(43) Pub. Date: Mar. 31, 2005

(54) System and method for operator assisted automated call handling

(76) Inventor: Xiaofan Lin, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/676,995

(22) Filed: Sep. 30, 2003

(51) Int. Cl. H04M 3/00; H04M 3/42; H04M 5/00

(52) U.S. Cl. 379/265.01; 379/211.02

(57) ABSTRACT

A system apparatus and method for operator assisted automated call handling is disclosed. The method discloses the elements of: initiating a dialog between a user and an automated call handling system; receiving input from a user in response to an input request by the system; sending a human operator the user input, if the system can not interpret the user input; providing the system with an interpreted response generated by the operator based on the user input; continuing the dialog between the user and the system if the interpreted response is confirmed by the user; and connecting the user to the operator if the interpreted response is not confirmed by the user. The system discloses means for practicing the method.

### BACKGROUND OF THE INVENTION

1. Field of the Invention

The present invention relates generally to systems apparatus and methods for automated call handling, and more particularly to a system and method for operator assisted automated call handling.

2. Discussion of Background Art

Automated call handling systems, such as Interactive Voice Response (IVR) systems, using Automatic Speech Recognition (ASR) and Text-to-speech (TTS) software are increasingly important tools for providing information and services in a more cost efficient manner. IVR systems are typically hosted by a server that includes an array of Digital Signal Processors (DSPs), and enable users to interact with corporate databases and services over a telephone using a combination of voice utterances and telephone button presses. IVR systems are particularly cost effective when a large number of users require data or services that are very similar in nature and thus can be handled in an automated manner often providing a substantial cost savings due to a need for fewer human operators.

In an ideal situation, an IVR system would be able to automatically guide a user through an entire transaction using only predefined dialogs, without any human interference. In reality, however, since speech recognition technology is still not perfect and perhaps will not be perfect for decades to come, from time to time, the user has to resort to a human operator after numerous unsuccessful communication efforts with the IVR system.

For example, while most users can put up with the machine-like TTS utterances and even the rigid dialog mode (i.e. step by step with a lot of confirmations), most users will not tolerate an IVR system that cannot recognize their voice response, even though they have repeatedly tried their best to speak it many times and as clearly as they can. Although the computer can be very patient and polite saying, “I'm sorry, but I cannot understand what you are saying. Would you please repeat?” users will get frustrated and form negative impressions of IVR systems, even if they are served well by a human operator in the end. Such users encountering IVR systems in the future often think that these systems are just too primitive, and thus will directly seek human assistance from the beginning of their call, and avoid the IVR system.

Toward this end, some IVR systems provide a hot key (for example, “#” key) or voice command (for example, “Help”) so that users can be connected to a human operator when there are problems. Once a user is transferred to a human operator the IVR system is terminated with respect to that user, and the human operator completes the transaction with the user. If such transfers from the IVR system to a human operator occur too often, the benefits of having an IVR system are reduced.

In response to the concerns discussed above, what is needed is an automated call handling system and method that overcomes the problems of the prior art.

### SUMMARY OF THE INVENTION

The present invention is a system and method for operator assisted automated call handling. The method of the present invention includes the elements of: initiating a dialog between a user and an automated call handling system; receiving input from a user in response to an input request by the system; sending a human operator the user input, if the system can not interpret the user input; providing the system with an interpreted response generated by the operator based on the user input; continuing the dialog between the user and the system if the interpreted response is confirmed by the user; and connecting the user to the operator if the interpreted response is not confirmed by the user. The system of the present invention includes all means for practicing the method.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of one embodiment of a system for operator assisted automated call handling; and

FIGS. 2A through 2C are a flowchart of one embodiment of a method for operator assisted automated call handling.

### DETAILED DESCRIPTION OF THE PREFERRED EMBODIMENT

The present invention addresses the problem where automated call handling systems are unable to resolve a user's speech signal utterance. In such instances, the present invention routes the speech signal to a human operator who then resolves the speech signal into a user response and provides that response back to the call handling system. Preferably human operators are used only to resolve a user's hard-to-understand utterances that Automatic Speech Recognition (ASR) software in the call handling system can not. The user need not be aware that the operator has helped or was involved at all and preferably continues to use the call handling system after the operator's help. This should improve a user's satisfaction with and continued use of such automated systems. The present invention also lowers call center costs, since the human operators are used mainly for specific portions of a user's call, and need not take over the entire call each time the call handling system can not resolve a user's utterance. The present invention preferably operates in conjunction with an Interactive Voice Response (IVR) system.

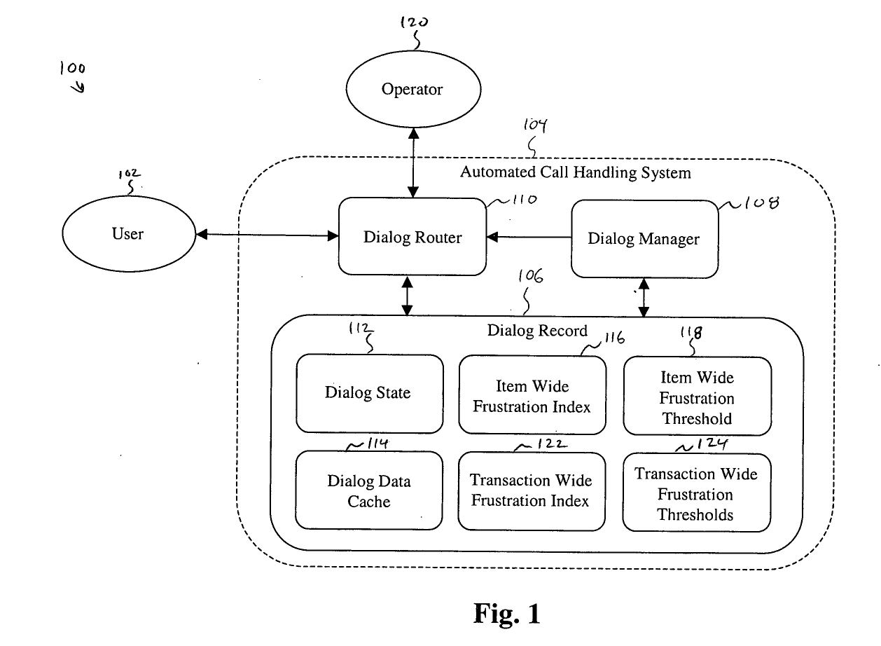

FIG. 1 is a dataflow diagram of one embodiment of a system 100 for operator assisted automated call handling. In response to a user 102 contacting the call handling system 104, a dialog record 106 specific to the user 102 is created. A dialog manager 108 routes user and system 104 information through a dialog router 110 to the dialog record 106. The dialog record 106 stores a record of interactions between the user 102 and the call handling system 104. These interactions are also preferably labeled as a dialog between the user 102 and the system 104, but alternatively may be labeled as a session or a transaction. During normal operation of the present invention, multiple instances of the dialog record 106 are likely as many users contact the call handling system 104 simultaneously.

The call handling system 104 creates and maintains a dialog state 112 and a dialog data cache 114 within the dialog record 106. The dialog state 112 includes a set of pointers that indicate a current state and a set of historic user states within the call handling system 104. The set of pointers also includes a set of path pointers that indicate how the user 102 reached the current user state within the call handling system 104. For example, the user 102 may have already gone through one branch of a question and answer tree that requested that the user 102 identify themselves to the call handling system 104. The dialog state 112 will have a record of this branch. The user 102 may now be at a current call handling system state where the user 102 is permitted to request a set of services hosted by or data from the call handling system 104.

The dialog data cache 114 can include data input by the user 102, such as a set of user answers in response to call handling session 104 questions, a set of telephone key presses, and or a set of user speech signal utterances. The dialog data cache 114 also can include data output to the user 102, such as bank records, outstanding customer service items, as well as many other types of data that can be processed by the call handling system 104. The call handling system 104 draws on Automatic Speech Recognition (ASR) and Text-to-speech (TTS) software modules (not shown) at various times in order to interpret the user's speech signals, maintain the dialog state 112, store information in the dialog data cache 114, and generate audible call handling system 104 responses that the user 102 can listen to.

The dialog manager 108 creates a user specific instance of an Item Wide Frustration Index 116 and a predetermined Item Wide Frustration Threshold 118, within the dialog record 106. The Item Wide Frustration Index 116 is a number that is incremented and reset by the dialog manager 108 in response to a predetermined set of events occurring within the call handling system 104. The Item Wide Frustration Index 116 is intended to correspond to an instantaneous user frustration level at a current state of the dialog record 106. The dialog manager 108 resets the Item Wide Frustration Index 116 to an initial value, such as zero, upon first contact with the call handling system 104 by the user 102.

The Item Wide Frustration Threshold 118 can be selected in many different ways. In a first embodiment, the dialog manager 108 can set the Item Wide Frustration Threshold 118 to a fixed value, such as three. In a second embodiment, the dialog manager 108 can look up an importance attribute associated with the user 102 and set the Item Wide Frustration Threshold 118 to a predetermined low value, if the user's 102 importance attribute is of a predetermined high value. The dialog manager 108 can set the Item Wide Frustration Threshold 118 to a predetermined high value, if the user's 102 importance attribute is of a predetermined low value.

In a third embodiment, the dialog manager 108 can look up a personality attribute associated with the user 102 and set the Item Wide Frustration Threshold 118 to a predetermined low value, if the user's 102 personality attribute is of a predetermined low frustration tolerance value. The dialog manager 108 can set the Item Wide Frustration Threshold 118 to a predetermined high value, if the user's 102 personality attribute is of a predetermined high frustration tolerance value. The frustration tolerance level can also be interpreted as a user patience level.

In a fourth embodiment, the dialog manager 108 can look up a physical attribute associated with the user 102 and set the Item Wide Frustration Threshold 118 to a predetermined low value, if the user's 102 physical attribute is of a first predetermine value. The dialog manager 108 can set the Item Wide Frustration Threshold 118 to a predetermined high value, if the user's 102 physical attribute is of a second predetermined value. Physical attributes can include a user's age, gender, and so on.

In a fifth embodiment, the dialog manager 108 can look up a call connection attribute associated with the user 102 and set the Item Wide Frustration Threshold 118 to a predetermined low value, if the user's 102 call connection attribute is of a first predetermine value. The dialog manager 108 can set the Item Wide Frustration Threshold 118 to a predetermined high value, if the user's 102 call connection attribute is of a second predetermined value. Call connection attributes can include whether or not the user 102 is calling from a mobile phone, whether or not the user is driving in a car, and so on. Call connection attributes can be determined in some cases by look-up tables by user and in other cases by using signal pre-analysis.

And, in a sixth embodiment, the dialog manager 108 can look up an operator availability attribute associated with the call handling system 104 and set the Item Wide Frustration Threshold 118 to a predetermined low value, if a relatively lower number of human operators are available to help the user 102. The dialog manager 108 can set the Item Wide Frustration Threshold 118 to a predetermined high value, if a relatively higher number of human operators are available to help the user 102. Usually, if there are a large number of operators available to assist the user 102 the threshold 118 will be set lower than if there were only a small number of available operators.

From time to time the call handling system 104 will request that the user 102 respond to the system 104 in some way. The requested response may solicit from the user 102 a button press, a vocal utterance, or other form of user response. The user 102 transmits the user response to the call handling system 104. If the call handling system 104 can not interpret the user response, the dialog manager 108 increments the Item Wide Frustration Index 116, and compares the Item Wide Frustration Index 116 with the predetermined Item Wide Frustration Threshold 118. If the Item Wide Frustration Index 116 is below the predetermined Item Wide Frustration Threshold 118, the dialog manager 108 instructs the call handling system 104 to repeat the user response request.

If the Item Wide Frustration Index 116 is at or above the predetermined Item Wide Frustration Threshold 118, the dialog manager 108 does not interrupt the dialog between the user 102 and the system 104, but instead: first, sends a human operator 120 the current state information stored in the dialog state 112; second sends the operator 120 a relevant set of user responses, such as the user's speech signal, stored in the dialog data cache 114; and third resets the Item Wide Frustration Index 116 back to it's initial value. The current state information provides the operator 120 with contextual information with regard to the current state of the dialog between the user 102 and the call handling system 104. The operator 120 then examines the current state information and the user responses. For instance, the contextual information may include a question requiring the user 102 to enter vacation destination name. Next, the operator 120 listens to the cached user responses.

If the operator 120 can interpret the user responses, the operator 120 provides the call handling system 104 with an interpreted response. The call handling system 104 asks the user 102 if the interpreted response corresponds to the user's intended response. If the interpreted response corresponds to the user's intended response, the call handling system 104 continues interacting with the user 102. The user 102 need not even know that the operator 120 was involved in generating the interpreted response.

If the interpreted response does not correspond to the user's intended response, the dialog manager 108 interrupts the dialog between the user 102 and the system 104 and commands the dialog router 110 to connect the user 102 directly to the operator 120. The operator 120 then enters in to a normal human dialog with the user 102 in order to determine what the user's 102 intended response was. Based on the operator's 120 judgment, the user 102 may or may not be passed back to the call handling system 104 in order to complete the user's transaction.

The dialog manager 108 also commands the dialog router 110 to connect the user 102 directly to the operator 120 at any point in the dialog, if the user 102 begins to speak out of context. An example of out of context user information includes when the user 102 starts to complain about the foolishness of the call handling system 104 after getting impatient. Out of context information can be detected by comparing the user's 102 responses to a known set of predefined words associated with user frustration.

The call handling system 104 creates a user specific instance of a Transaction Wide Frustration Index 122, and a set of Transaction Wide Frustration Thresholds 124, within the dialog record 106. The Transaction wide Frustration Index 120 is a number that is incremented and reset by the dialog manager 108 in response to a predetermined set of events occurring within the call handling system 104. The Transaction Wide Frustration Index 122 is intended to correspond to an overall user frustration level with the call handling system 104, as recorded within the entire dialog record 106. The dialog manager 108 resets the Transaction Wide Frustration Index 122 to an initial value, such as zero, upon first contact with the call handling system 104 by the user 102.

The Transaction Wide Frustration Thresholds 124 can be selected in many different ways, including those discussed above with respect to the Item Wide Frustration threshold. If the Item Wide Frustration threshold 118 has been reached or exceeded, the dialog manager 108 increments the Transaction Wide Frustration Index 122, and compares the Transaction Wide Frustration Index 122 with a first Transaction Wide Frustration Threshold within the set of thresholds 124.

If the Transaction Wide Frustration Index 122 is below the first Transaction Wide Frustration Threshold, the dialog manager 108 does not interrupt the call handling system's 104 dialog with the user 102. If the Transaction Wide Frustration Index 122 is at or above the first Transaction Wide Frustration Threshold, the dialog manager 108 transmits a warning signal to the operator 120 and provides the operator 120 with an option to interrupt the dialog and directly connect to the user 102 through the dialog router 110. If the Transaction Wide Frustration Index 122 is at or above a second Transaction Wide Frustration Threshold, which is higher than the first Transaction Wide Frustration Threshold, the dialog manager 108 automatically commands the dialog router 110 to connect the user 102 directly to the operator 120. The operator 120 then enters in to a normal human dialog with the user 102.

Data collected by the present invention may also be used as a ground-truthing engine for improving the call handling system 104 and setting the thresholds.

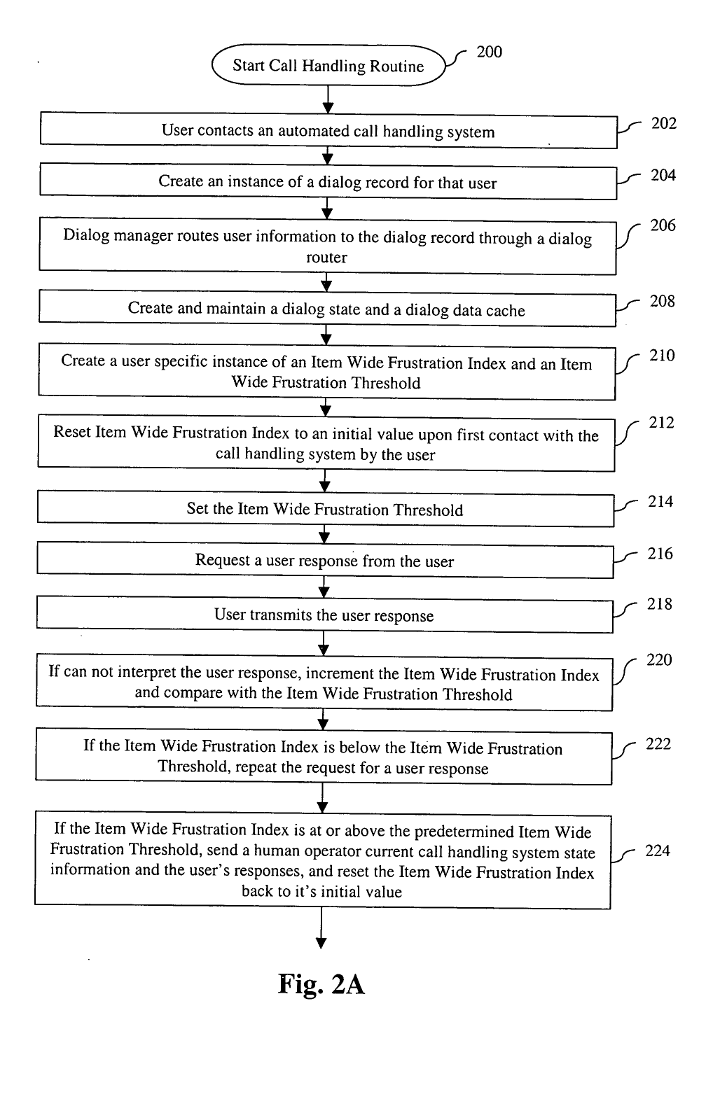

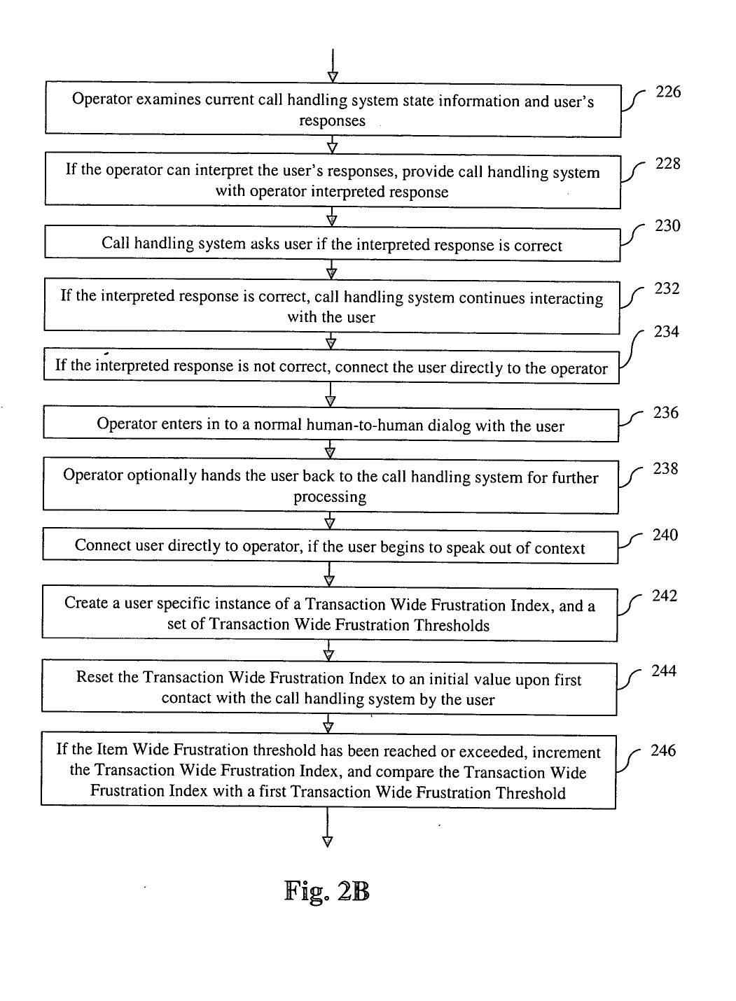

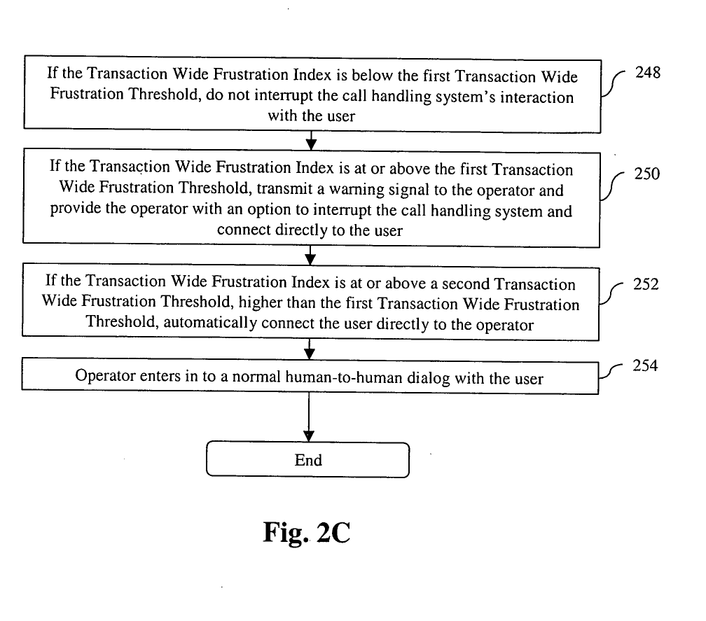

FIGS. 2A through 2C are a flowchart of one embodiment of a method 200 for operator assisted automated call handling. The method 200 begins in step 202, where a user 102 contacts and enters into a dialog with the call handling system 104. In step 204, the call handling system 104 creates an instance of a dialog record 106 for that user 102, and in step 206, a dialog manager 108 routes the dialog information to the dialog record 106 through a dialog router 110.

In step 208, the call handling system 104 creates and maintains a dialog state 112 and a dialog data cache 114 within the dialog record 106. In step 210, the dialog manager 108 creates a user specific instance of an Item Wide Frustration Index 116 and a predetermined Item Wide Frustration Threshold 118, within the dialog record 106.

In step 212, the dialog manager 108 resets the Item Wide Frustration Index 116 to an initial value, such as zero, upon first contact with the call handling system 104 by the user 102. In step 214, the dialog manager 108 sets the Item Wide Frustration Threshold 118, as discussed above.

In step 216, as part of the dialog record 106, the call handling system 104 requests a response from the user 102. In step 218, the user 102 transmits the response to the call handling system 104. In step 220, if the call handling system 104 can not interpret the user response, the dialog manager 108 increments the Item Wide Frustration Index 116, and compares the Item Wide Frustration Index 116 with the predetermined Item Wide Frustration Threshold 118. In step 222, if the Item Wide Frustration Index 116 is below the predetermined Item Wide Frustration Threshold 118, the dialog manager 108 instructs the call handling system 104 to repeat the request for a user response, and the method 200 returns to step 216.

In step 224, if the Item Wide Frustration Index 116 is at or above the predetermined Item Wide Frustration Threshold 118, the dialog manager 108: first, sends a human operator 120 the current state information from the dialog state 112; second sends the operator 120 the user responses, such as the user speech signals, stored in the dialog data cache 114; and third resets the Item Wide Frustration Index 116 back to it's initial value. The current state information provides the operator 120 with contextual information describing the current state of the dialog between the user 102 and the call handling system 104. In step 226, the operator 120 examines the current state information and the user responses.

In step 228, if the operator 120 can interpret the user responses, the operator 120 provides the call handling system 104 with an interpreted response. In step 230, the call handling system 104 asks the user 102 if the interpreted response corresponds to the user's intended response (i.e. Does the user confirm that the operator's interpreted response is correct?). In step 232, if the interpreted response corresponds to the user's intended response, the call handling system 104 continues the dialog with the user 102.

In step 234, if the interpreted response does not correspond to the user's intended response, the dialog manager 108 automatically commands the dialog router 110 to interrupt the dialog between the user 102 and the system 104, and connects the user 102 directly to the operator 120. In step 236, the operator 120 enters in to a normal human dialog with the user 102 in order to determine what the user's 102 intended response was. In step 238, based on the operator's 120 judgment, the operator 120 optionally connects the user 102 back to the call handling system 104 in order to complete the user's transaction.

In step 240, the dialog manager 108 also automatically commands the dialog router 110 to connect the user 102 directly to the operator 120, if the user 102 begins to speak out of context.

In step 242, the call handling system 104 creates a user specific instance of a Transaction Wide Frustration Index 122, and a set of Transaction Wide Frustration Thresholds 124, within the dialog record 106. In step 244, the dialog manager 108 resets the Transaction Wide Frustration Index 122 to an initial value, such as zero, upon first contact with the call handling system 104 by the user 102.

The Transaction Wide Frustration Thresholds 124 can be selected in many different ways, and may differ from user to user in a manner equivalent to that presented with respect to step 214. In step 246, if the Item Wide Frustration threshold 118 has been reached or exceeded, the dialog manager 108 increments the Transaction Wide Frustration Index 122, and compares the Transaction Wide Frustration Index 122 with a first Transaction Wide Frustration Threshold within the set of thresholds 124.

In step 248, if the Transaction Wide Frustration Index 122 is below the first Transaction Wide Frustration Threshold, the dialog manager 108 does not interrupt the call handling system's 104 dialog with the user 102. In step 250, if the Transaction Wide Frustration Index 122 is at or above the first Transaction Wide Frustration Threshold, the dialog manager 108 transmits a warning signal to the operator 120 and provides the operator 120 with an option to interrupt the dialog between the user 102 and the system 104, and directly connect to the user 102 through the dialog router 110.

In step 252, if the Transaction Wide Frustration Index 122 is at or above a second Transaction Wide Frustration Threshold, which is higher than the first Transaction Wide Frustration Threshold, the dialog manager 108 automatically commands the dialog router 110 to connect the user 102 directly to the operator 120. In step 254, the operator 120 then enters in to a normal human dialog with the user 102.

While one or more embodiments of the present invention have been described, those skilled in the art will recognize that various modifications may be made. Variations upon and modifications to these embodiments are provided by the present invention, which is limited only by the following claims.

1. A method for call handling, comprising:
initiating a dialog between a user and an automated call handling system;
receiving input from a user in response to an input request by the system;
sending a human operator the user input, if the system can not interpret the user input;
providing the system with an interpreted response generated by the operator based on the user input;
continuing the dialog between the user and the system if the interpreted response is confirmed by the user; and
connecting the user to the operator if the interpreted response is not confirmed by the user.

2. The method of claim 1 wherein the call handling system is an Interactive Voice Response system.

3. The method of claim 1:
wherein the receiving element includes,
incrementing an Item Wide Frustration Index, if the system can not interpret the user input; and
repeating the input request, if the Item Wide Frustration Index is below a predetermined Item Wide Frustration Threshold; and
wherein the sending element includes:
sending the human operator the user input, if the Item Wide Frustration Index is above the predetermined Item Wide Frustration Threshold; and
resetting the Item Wide Frustration Index back to an initial value.

4. The method of claim 1:
wherein the sending element includes,
sending a human operator contextual information with respect to the input request and a set of user inputs generated by the user in response to the input request; and
wherein the providing element includes,
permitting the operator to view the contextual information; and
playing back the user inputs for the operator.

5. The method of claim 1 further comprising:
connecting the user to the operator if the user begins to speak out of context.

6. The method of claim 3 wherein the initiating element includes:
setting the Item Wide Frustration Threshold to a fixed value.

7. The method of claim 3 wherein the initiating element includes:
setting the Item Wide Frustration Threshold to a predetermined value dependent upon an importance attribute associated with the user.

8. The method of claim 3 wherein the initiating element includes:
setting the Item Wide Frustration Threshold to a predetermined value dependent upon a personality attribute associated with the user.

9. The method of claim 3 wherein the initiating element includes:
setting the Item Wide Frustration Threshold to a predetermined value dependent upon a frustration tolerance associated with the user.

10. The method of claim 3 wherein the initiating element includes:
setting the Item Wide Frustration Threshold to a predetermined value dependent upon a patience attribute associated with the user.

11. The method of claim 3 wherein the initiating element includes:
setting the Item Wide Frustration Threshold to a predetermined value dependent upon a physical attribute associated with the user.

12. The method of claim 3 wherein the initiating element includes:
setting the Item Wide Frustration Threshold to a predetermined value dependent upon a call connection attribute associated with the user.

13. The method of claim 3 wherein the initiating element includes:
setting the Item Wide Frustration Threshold to a predetermined value dependent upon an operator availability attribute associated with the system.

14. The method of claim 3, wherein the sending element includes:
incrementing a Transaction Wide Frustration Index if the Item Wide Frustration Index is above the predetermined Item Wide Frustration Threshold;
providing the operator with an option to connect to the user if the Transaction Wide Frustration Index is above a first Transaction Wide Frustration Threshold; and
connecting the user to the operator if the Transaction Wide Frustration Index is above a second Transaction Wide Frustration Threshold.

15. A method for call handling, comprising:
initiating a dialog between a user and an automated call handling system;
receiving input from a user in response to an input request by the system;
sending a human operator the user input, if the system can not interpret the user input;
providing the system with an interpreted response generated by the operator based on the user input;
continuing the dialog between the user and the system if the interpreted response is confirmed by the user;
connecting the user to the operator if the interpreted response is not confirmed by the user; and
wherein the receiving element includes,
incrementing an Item Wide Frustration Index, if the system can not interpret the user input; and
repeating the input request, if the Item Wide Frustration Index is below a predetermined Item Wide Frustration Threshold; and
wherein the sending element includes,
sending the human operator the user input, if the Item Wide Frustration Index is above the predetermined Item Wide Frustration Threshold; and
resetting the Item Wide Frustration Index back to an initial value; and
wherein the sending element includes,
incrementing a Transaction Wide Frustration Index if the Item Wide Frustration Index is above the predetermined Item Wide Frustration Threshold;
providing the operator with an option to connect to the user if the Transaction Wide Frustration Index is above a first Transaction Wide Frustration Threshold; and
connecting the user to the operator if the Transaction Wide Frustration Index is above a second Transaction Wide Frustration Threshold.

16. A system apparatus for call handling, comprising a:
means for initiating a dialog between a user and an automated call handling system;
means for receiving input from a user in response to an input request by the system;
means for sending a human operator the user input, if the system can not interpret the user input;
means for providing the system with an interpreted response generated by the operator based on the user input;
means for continuing the dialog between the user and the system if the interpreted response is confirmed by the user; and
means for connecting the user to the operator if the interpreted response is not confirmed by the user.

17. A system for automated call handling, comprising:
a set of modules, for initiating a dialog with a user and receiving input from the user in response to an input request;
a dialog router, for routing user and system information;
an operator, and
a dialog manager,
for sending the operator the user input, if the system can not interpret the user input;
for receiving an interpreted response from the operator based on the user input;
for continuing the dialog between the user and the system if the interpreted response is confirmed by the user; and
for connecting the user to the operator through the dialog router if the interpreted response is not confirmed by the user.

18. The system of claim 17, further comprising:
a dialog record, for storing a record of the dialog between the user and the system.
